(19) United States
(12) Patent Application Publication
(10) Pub. No.: US 2012/0317775 A1
(43) Pub. Date: Dec. 20, 2012

(54) Tool remover

(76) Inventor: Rodney John Lamash, Edmonton (CA)

(21) Appl. No.: 13/067,619

(22) Filed: Jun. 15, 2011

(51) Int. Cl. B23P 19/00; B25B 27/14

(52) U.S. Cl. 29/426.5; 29/281.1

(57) ABSTRACT

An apparatus and method for removing a shaft of a tool from a retainer. The apparatus comprises a first plate having a bore therethrough oriented to be parallel with an axis of the tool, a second annular u-shaped plate sized to bear against a first surface of the retainer and at least one connector extending between the first and second plates. The apparatus further comprises a clamping member received within the bore, adapted to be forced therethough so as to apply an axial compressive force to an end of the shaft from the bracket bearing against the first surface of the retainer. The method comprises securing a bracket to the retainer, applying an axial compressive force to an end of the shaft from the bracket bearing against a first surface of the retainer, applying heat to the retainer and applying an impact to the retainer.

### BACKGROUND OF THE INVENTION

1. Field of Invention

The present invention relates to tool removers in general and in particular to a method and apparatus for removing a shaft of a tool from an interference fitting retainer.

2. Description of Related Art

Many powered machinery utilize a power unit driving a tool to perform a task. One example of such a tool is a tamping machine. Tamping machines have a plurality of tamping tools, each located within a tool retainer for use in tamping ballast along a railroad track.

In conventional tamping machines, the tamping tool includes working or tool end and an opposed shank or shaft end. The shaft of the tamping tool is received within the retainer and secured therein by a bolt. Optionally the shaft of the tamping tool may be tapered so as to be received within a corresponding tapered bore in the retainer.

Although tamping tools are designed to be removable from their receivers, such removal is often difficult. During operation, the shaft of the tamping tool is forced further into the retainer due to the operation of the tamping machine as well as the initial installation of the tamping tool therein. Such an interference fit between the tamping tool shaft and the retainer makes removal of the tamping tool difficult such that conventional methods of removing the tamping tools for maintenance and replacement have not been satisfactory.

Many tamping tools include a flange extending therearound proximate to and below the receiver. Conventional methods of removing tamping tools has been to abut against or otherwise engage the flange and pull the tamping tool out of the retainer by the application of a downward force. Examples of devices for use with such a method are illustrated in U.S. Pat. No. 5,125,145 to Williams. Such methods have not be sufficiently reliable to remove tamping tools having greater degrees of interference fit within the retainer due to the possibility of shearing the flange off of the tamping tool or due to tensile failure of the tamping tool itself. Additionally, for applications where the removal of the shaft of the tamping tool is necessitated by the failure of the tamping tool itself, such devices may be unsuitable due to the lack of a flange to engage upon where the failure of the tamping tool has occurred above the flange.

### SUMMARY OF THE INVENTION

According to a first embodiment of the present invention there is disclosed an apparatus for removing a shaft of a tool from a retainer. The retainer has a passage extending between a first surface disposed towards a working end of the tool and a second opposed surface wherein the passage holds the shaft in an interference fit. The apparatus comprises a first plate having a bore therethrough oriented to be parallel with an axis of the tool, a second annular u-shaped plate sized to bear against the first surface of the retainer and at least one connector extending between the first and second plates. The apparatus further comprises a clamping member received within the bore, adapted to be forced therethough so as to apply an axial compressive force to an end of the shaft from the bracket bearing against the first surface of the retainer.

The tool may comprise a tamping tool and the retainer may comprise a tamping tool retainer. The clamping member may comprise a threaded member wherein the bore of the first plate comprises a corresponding threaded bore. The threaded member may comprise a bolt.

The first and second plates may be spaced apart by a distance sufficient to receive the retainer therebetween. The at least one connector may comprise a pair of spaced apart connection plates extending between the first and second plates. The pair of connection plates may be located to opposed sides of an opening of the second u-shaped plate.

According to a further embodiment of the present invention there is disclosed a method for removing a shaft of a tool from a retainer. The retainer has a passage extending between a first surface disposed towards a working end of the tool and a second opposed surface wherein the passage holds the shaft in an interference fit. The method comprises securing a bracket to the retainer, applying an axial compressive force to an end of the shaft from the bracket bearing against the first surface of the retainer, applying heat to the retainer and applying an impact to the retainer. Applying the axial pressure may comprise turning a threaded post received within a top portion of the bracket.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus according to a first embodiment of the present invention applied to a tamping tool and retainer.

FIG. 2 is a perspective view of the apparatus of FIG. 1.

FIG. 3 is a cross sectional view of the apparatus applied to a tamping tool and retainer as taken along the line 3-3 of Figure.

FIG. 4 is a perspective view of the apparatus of FIG. 2 applied to the tamping tool and retainer with a heat source being applied to the retainer.

FIG. 5 is a perspective view of the apparatus of FIG. 2 applied to the tamping tool and retainer with an impact being applied to the retainer.

FIG. 6 is a perspective view of the tamping tool and the apparatus of FIG. 1 being removed from the and retainer.

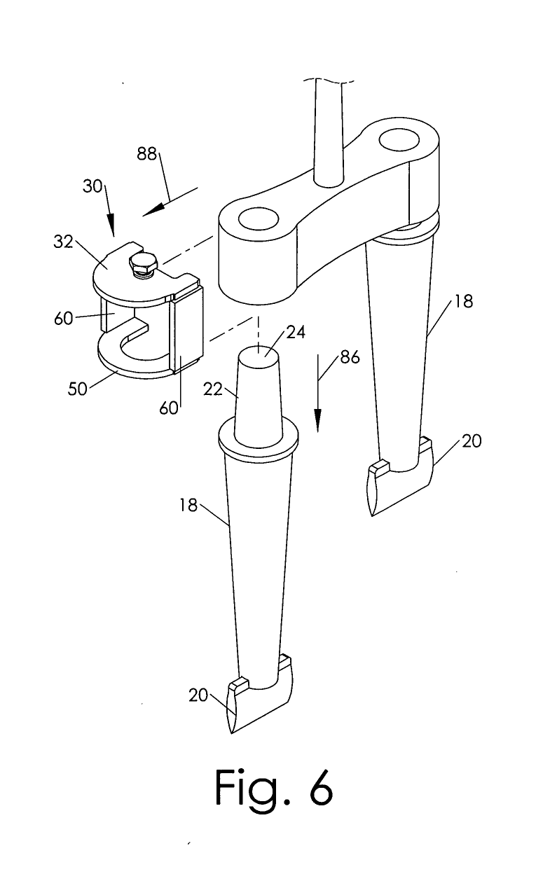

### DETAILED DESCRIPTION

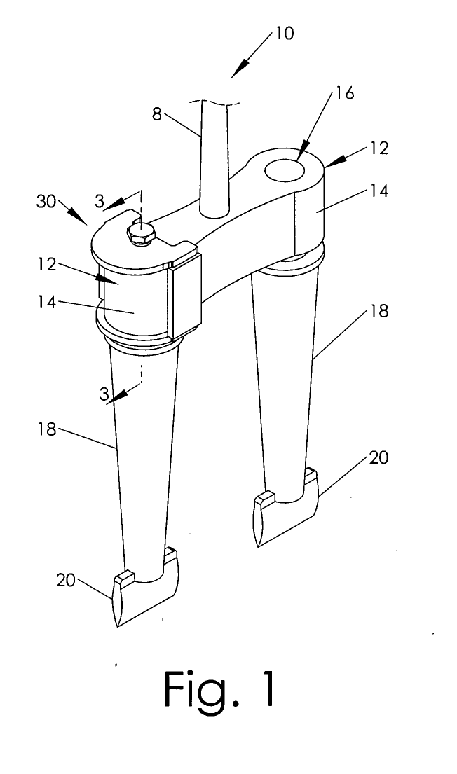

Referring to FIG. 1, an tamping assembly is shown generally at 10 having a pair of tamping tool retainer 12 supported from a central region or driving shaft 8. Each tamping tool retainer 12 comprises a retainer body 14 having a retainer bore 16 extending therethrough. The retainer bore 16 receives and retains therein a tamping tool 18 therein. The tamping tool 18 comprises an elongate member extending between a distal tool or working end 20 and a proximate shaft or shank end 22 (not shown in FIG. 1). The tamping tool shaft 22 is received within the retainer bore 16 in an interference or press fit as is conventionally known in the art.

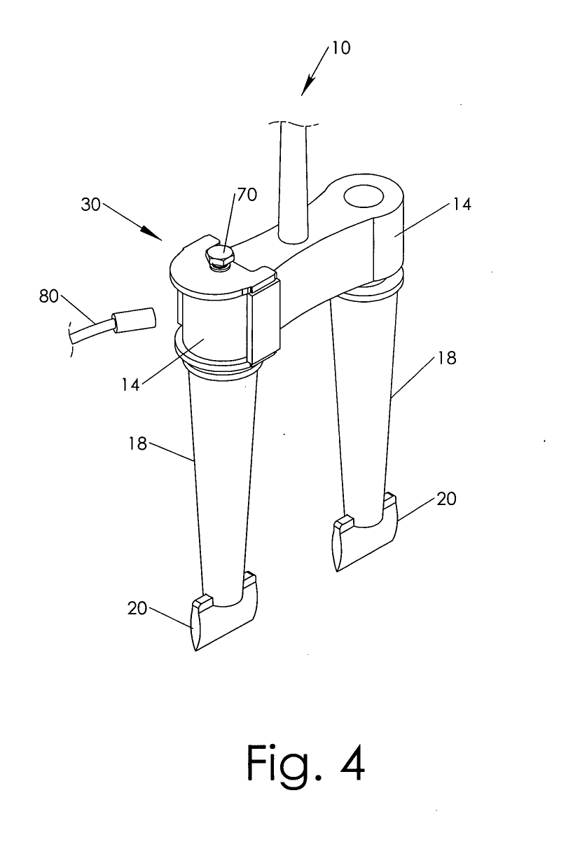

As illustrated in FIGS. 1 and 4, an apparatus for removing a shaft of the tamping tool from the retainer is illustrated generally at 30 applied to one of the retainers 12. The apparatus 30 comprises a top or first plate 32 having a clamping member 70 extending therethrough, a bottom or second plate 50 and at least one connector 60 extending therebetween. In operation, the apparatus 30 may be utilized to remove a tamping tool 18 or a shaft 22 thereof by pressing the clamping member in a generally downward motion to bear against a top surface 24 of the tamping tool 18 and press the shaft 22 through the retainer bore 16 as will be further described below.

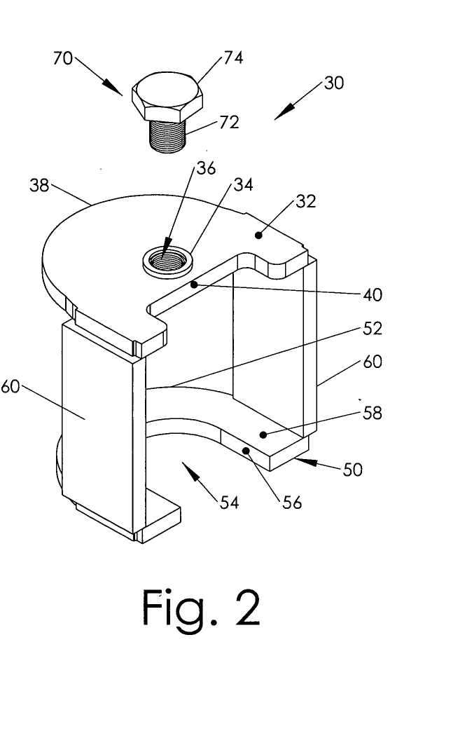

Turning now to FIG. 2, an exploded view of the apparatus 30 is illustrated. As indicated above, the apparatus 30 comprises a top plate 32, a bottom plate 50 and at least one connector 60 extending therebetween. The top plate 32 comprises a substantially planar member having a raised central portion 34 and a threaded bore 36 therethrough. As illustrated the top plate 32 may have a substantially circular outline, generally indicated at 38 with straight edge 40, although it will be appreciated that other outline shapes may be useful as well, such as by way of non-limiting example, square, triangular, octagonal or irregular.

The bottom plate 50 comprises a substantially planar member having an outline, generally indicated at 52, corresponding approximately to the outline of the top plate 32 and a central passage 54 defined by an interior edge 56 of the bottom plate 50. It will be appreciated that the bottom plate in such an arrangement may have a substantially u-shaped outline. The central passage 54 is selected to have a size sufficient to permit the shaft 22 of the tamping tool 18 to freely pass therethrough while providing an interior shoulder 58 adapted to abut against a bottom surface of the retainer body 14. In practice, it has been found that a width of between 2¼ and 2¾ inches (57 and 70 mm) has been sufficient for a standard sized tamping tool although it will be appreciated that other dimensions may be useful as well for other sizes of tamping tools.

The connectors 60 extend between and rigidly space the top and bottom plates 32 and 50 apart from each other in parallel spaced apart relation. The top and bottom plates 32 and 50 are spaced apart by a distance sufficient to receive the retainer body 14 therebetween. In practice, it has been found that a distance of between 4 and 4½ inches (102 and 114 mm) is sufficient for most tamping tool retainers although it will be appreciated that other distances may be useful as well. As illustrated, the apparatus 30 may include two connectors 60 extending between the top and bottom plates 32 and 50, although it will be appreciated that other quantities of connectors may be utilized as well. As illustrated in FIG. 2, the connectors 60 may be located to opposed sides of the threaded bore 36 although it will be appreciated that other locations may be utilized as well. The connectors 60 may be secured to the top and bottom plates 32 and 50 through the use of welding, fasteners, adhesives or the like or may optionally be integrally formed therewith, such as through casting or machining. The top plate 32, bottom plate 50 and connectors 60 may be formed of any suitably strong material such as, by way of non-limiting example steel, stainless steel, or alloys. In forming the apparatus, the thickness of the top and bottom plates 32 and 50 as well as the connectors should be selected to have sufficient strength to apply a suitable compressive force to the top surface 24 of the tamping tool 18. By way of non-limiting example, the top and bottom plates 32 and 50 may have a thickness of between ¼ and 1½ inches (6 and 38 mm).

As illustrated in FIG. 2, the clamping member 70 may comprise a bolt or other suitable fastener having a threaded portion 72 threadably received within the threaded bore and a head portion 74 as are commonly known. As illustrated, the head portion 74 may be located exterior to the apparatus 30 such that a wrench may be easily engaged thereupon. The clamping member 70 may thereafter be turned so as to longitudinally displace the clamping member therein so as to apply a compressive force to the top surface 24 of the tamping tool 18. The clamping member 70 should have a size and threading selected to provide a suitably high compressive force to the top surface 24 of the tamping tool. By way of non-limiting example, the clamping member 70 may comprise a bolt having threading applied thereto such as by way of non-limiting example, a ⅞ inch diameter by 1½ inch length grade 8 fine thread hex cap screw. It will be appreciated that the length of the bolt will often be selected so as to not interfere with the gear case (not shown) of the tamping assembly above. Optionally, the clamping member 70 may also comprise any other means of applying a compressive force to the top surface 24 of the tamping tool 18, such as, by way of non-limiting example a lever or piston and cylinder.

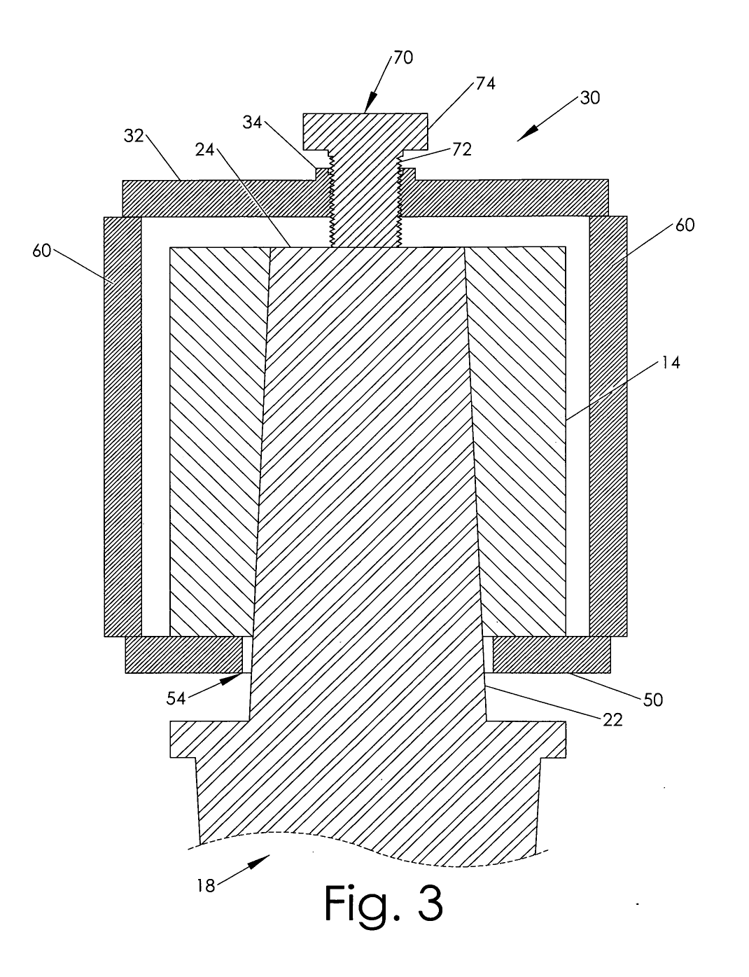

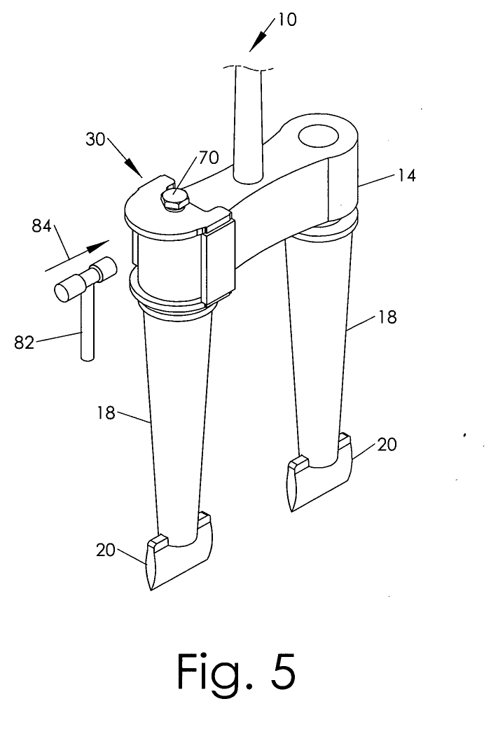

In operation, the apparatus may be applied to one of the retainer bodies 14 as illustrated in FIGS. 1 and 3 and the clamping member 70 may be tightened or otherwise clamped upon the top surface 24 of the tamping tool. Thereafter, a heat source, such as by way of non-limiting example a propane torch 80 or the like may be applied to the outside surface of the retainer body 14 as illustrated in FIG. 4. After heating to a sufficient temperature, the retainer body 14 may be impacted by a hammer 82 or the like by moving it in a direction generally indicated at 84 in FIG. 5. If the tamping tool 18 is not thereby removed from the retainer body, the clamping member 70 may be retightened and heat and several impacts reapplied to the retainer body until the tamping tool 18 is successfully removed in a downward direction generally indicated at 86. Thereafter the apparatus may be removed from the retainer body 14 in a direction generally indicated at 88. Optionally, shims (not shown) may be located between the bottom plate 50 and the retainer body 14 if the length of the clamping member is not sufficient to remove the tamping tool shaft 22 from the retainer bore 16.

While specific embodiments of the invention have been described and illustrated, such embodiments should be considered illustrative of the invention only and not as limiting the invention as construed in accordance with the accompanying claims.

What is claimed is:

1. An apparatus for removing a shaft of a tool from a retainer, the retainer having a passage extending between a first surface disposed towards a working end of said tool and a second opposed surface, said passage holding said shaft in an interference fit, the apparatus comprising:
a first plate having a bore therethrough oriented to be parallel with an axis of said tool;
a second annular u-shaped plate sized to bear against said first surface of said retainer;
at least one connector extending between said first and second plates; and
a clamping member received within said bore, adapted to be forced therethough so as to apply an axial compressive force to an end of said shaft from said bracket bearing against said first surface of said retainer.

2. The apparatus of claim 1 wherein said tool comprises a tamping tool and said retainer comprises a tamping tool retainer.

3. The apparatus of claim 1 wherein said clamping member comprises a threaded member wherein said bore of said first plate comprises a corresponding threaded bore.

4. The apparatus of claim 3 wherein said threaded member comprises a bolt.

5. The apparatus of claim 1 wherein said first and second plates are spaced apart by a distance sufficient to receive said retainer therebetween.

6. The apparatus of claim 1 wherein said at least one connector comprises a pair of spaced apart connection plates extending between said first and second plates.

7. The apparatus of claim 6 wherein said pair of connection plates are located to opposed sides of an opening of said second u-shaped plate.

8. A method for removing a shaft of a tool from a retainer, the retainer having a passage extending between a first surface disposed towards a working end of said tool and a second opposed surface, said passage holding said shaft in an interference fit, the method comprising:
securing a bracket to said retainer;
applying an axial compressive force to an end of said shaft from a said bracket bearing against said first surface of said retainer;
applying heat to said retainer; and
applying an impact to said retainer.

9. The method of claim 8 wherein said applying said axial pressure comprises turning a threaded post received within a top portion of said bracket.
